(19) United States
(12) Patent Application Publication
(10) Pub. No.: US 2015/0308681 A1
(43) Pub. Date: Oct. 29, 2015

(54) FLARE GAS ACTUATED VELOCITY SEAL AND METHOD OF USE THEREOF

(71) Applicant: Honeywell International, Inc., Morristown, NJ (US)

(72) Inventor: Matthew A. Martin, Tulsa, OK (US)

(21) Appl. No.: 14/680,604

(22) Filed: Apr. 7, 2015

Related U.S. Application Data
(60) Provisional application No. 61/983,676, filed on Apr. 24, 2014.

(51) Int. Cl. F23G 7/08; F16K 15/14

(52) U.S. Cl. CPC F23G 7/08; F16K 15/144

(57) ABSTRACT

A flare gas actuated velocity seal and method of use thereof. The velocity seal is actuated by increases and/or decreases in the pressure of a flare gas flow in a flare stack. The velocity seal is positioned upstream of a burner tip within the gas flow through the stack. The flare gas actuated velocity seal and method of use provide a back-pressure to the flare gas flow that is generally constant in proportion to the pressure of the gas flow preventing air from flowing into the stack even at very low rates.

### CROSS-REFERENCE TO RELATED APPLICATION

This application claims priority from Provisional Application No. 61/983,676 filed Apr. 24, 2014, the contents of which are hereby incorporated by reference.

### BACKGROUND OF THE INVENTION

This invention relates generally to a flare gas actuated velocity seal and method of use thereof, and more particularly to a flare gas actuated velocity seal and method of use that provide a back-pressure to flare gas that is generally constant in proportion to the flare gas flow preventing air from flowing into the flare stack even at very low rates.

Flare systems are used in various industries to provide safe disposal of flammable liquids or gases. Flare systems are combustion mechanisms to burn off flammable liquids or gases and, for example, may be used in industrial plants to burn off flammable gases released by pressure relief valves. Various types of flares exist, including elevated flares and flares that operate near grade. Near-grade level flares are often called ground flares.

In flares with a large turn-down ratio requirement, air ingress into a flare burner tip before ignition at low rates may cause burn-back or detonation in the flare tip with undesirable results. It can occur when the flame propagation velocity exceeds the discharge velocity of the fuel and air mixture exiting the flare tip. The differences in velocities can cause the flame to propagate back into the stack and ignite the mixture inside the flare tip, leading to noise, smoke, mechanical damage and/or thermal damage to the stack and/or the tip.

Preferably, the stack should be designed so that the discharge speed of the gas flow leaving the tip exceeds the flame speed. Flare tips generally feature assembly geometries that do not provide a uniform flow of the fuel and air mixture and gives way to acceleration and deceleration of the fuel and air mixture, causing a non-uniform flow. As a result of such non-uniform flow, turbulence is created. The resulting turbulence and differing velocities create non-uniform flow exiting the tip. In some locations, the velocity can be extremely high, greatly exceeding the flame propagation speed, while in other locations, the exit velocity can be extremely low, and in some cases even negative, creating “reverse” flow back into the tip. Flashback may occur in the low velocity regions.

It is therefore desirable to provide a flare gas actuated velocity seal and method of use thereof.

It is further desirable to provide a flare gas actuated velocity seal having a base supporting a plurality of radially converging flaps, which form a central bore along the flow path of the flare gas through a flare stack.

It is still further desirable to provide a method of controlling a flow of flare gas using a velocity seal that is actuated by increases and/or decreases in the flare gas pressure in a flare stack.

It is yet further desirable to provide a flare gas actuated velocity seal and method of use thereof that provide a back-pressure to flare gas that is generally constant in proportion to the gas flow, preventing air from flowing into the flare stack even at very low rates.

It is still yet further desirable to provide a flare gas actuated velocity seal and method of use thereof that can be tuned to a specific required back-pressure by making apertures in or otherwise changing the dimensions of the flaps of the velocity seal.

It is still yet further desirable to provide a flare gas actuated velocity seal and method of use thereof that increase the life of flare tips, act as a depressurizing safety means to increase safety, and prevent flow rate.

It is still yet further desirable to provide a flare gas actuated velocity seal and method of use thereof that decrease smoke output and require less steam during processing to maintain sufficient flow rates.

Other advantages and features will be apparent from the following description and from the claims.

### SUMMARY OF THE INVENTION

In general, in a first aspect, the invention relates to a flare gas actuated velocity seal having a base supporting a plurality of radially converging flaps. The flaps form a central bore through the seal along a flow path of flare gas. The flaps are pivotally connected to the base, such as to slotted receiving apertures in the base, and the flaps are movable between a closed position and an open position. The base of the velocity seal can be constructed of an annular body having a plurality of radially converging support arms, which form lower stops for the flaps. Each of the flaps can include a terminal shoulder engaged with the slotted receiving apertures in the base. The shoulders form upper stops for the flaps. In addition, one or more of the flaps can include a tuning aperture.

In general, in a second aspect, the invention relates to a method of controlling a flow of a flare gas in a flare stack using a flare gas actuated velocity seal. The velocity seal is movable between an open position and a closed position in response to increases and/or decreases in the pressure of the flare gas in the flare stack. The method can also include providing a back-pressure to the flare gas with the flaps of the velocity seal generally constant in proportion to the flare gas preventing air from flowing into the stack.

In general, in a third aspect, the invention relates to a method of controlling a flow of a flare gas in a flare stack. The method includes providing the flow of the flare gas to a flare gas actuated velocity seal positioned upstream of a burner tip in the flare stack and providing a back-pressure with a plurality of radially converging flaps of the velocity seal in generally constant proportion to the flare gas, preventing air from flowing into the stack. The flaps of the velocity seal are movable between an open position and a closed position in response to an increase and/or a decrease in the flare gas in the flare stack. In addition, the method includes providing the velocity seal in a path of the flare gas in a single main flare stack or in one or more of radial arm assemblies in fluid communication with the flare stack.

### BRIEF DESCRIPTION OF THE DRAWINGS

FIG. 1 is a partial cutaway perspective view of an example of a flare stack having a velocity seal in accordance with an illustrative embodiment of the flare gas actuated velocity seal and method of use thereof disclosed herein.

FIG. 2 is a partial cutaway perspective view of another example of a flare stack having a velocity seal in accordance with an illustrative embodiment of the flare gas actuated velocity seal and method of use thereof disclosed herein.

FIG. 3 is an upper perspective view of an example of a flare gas actuated velocity seal in a closed position in accordance with an illustrative embodiment of the invention disclosed herein.

FIG. 4 is a lower perspective view of the velocity seal shown in FIG. 3.

FIG. 5 is a partial cutaway perspective view of the velocity seal shown in FIG. 3.

FIG. 6 is a perspective view of the velocity seal illustrated in FIG. 3 shown in a partially open position.

FIG. 7 is a perspective view of the velocity seal illustrated in FIG. 3 shown in a fully open position.

FIG. 8 is an upper perspective view of another example of a flare gas actuated velocity seal in accordance with an illustrative embodiment of the invention disclosed herein.

### DETAILED DESCRIPTION OF THE PREFERRED EMBODIMENTS

The devices and methods discussed herein are merely illustrative of specific manners in which to make and use this invention and are not to be interpreted as limiting in scope.

While the invention has been described with a certain degree of particularity, it is to be noted that many modifications may be made in the construction and the arrangement of the structural and function details disclosed herein without departing from the scope of the invention. It is understood that the invention is not limited to the embodiments set forth herein for purposes of exemplification.

The description of the invention is intended to be read in connection with the accompanying drawings, which are to be considered part of the entire written description of this invention. In the description, relative terms such as “front,” “rear,” “lower,” “upper,” “horizontal,” “vertical,” “above,” “below,” “up,” “down,” “top” and “bottom” as well as derivatives thereof (e.g., “horizontally,” “downwardly,” “upwardly”, etc.) should be construed to refer to the orientation as then described or as shown in the drawings under discussion. These relative terms are for convenience of description and do not require that the machine be constructed or the method to be operated in a particular orientation. Terms, such as “connected,” “connecting,” “attached,” “attaching,” “join” and “joining”, are used interchangeably and refer to one structure or surface being secured to another structure or surface or integrally fabricated in one piece.

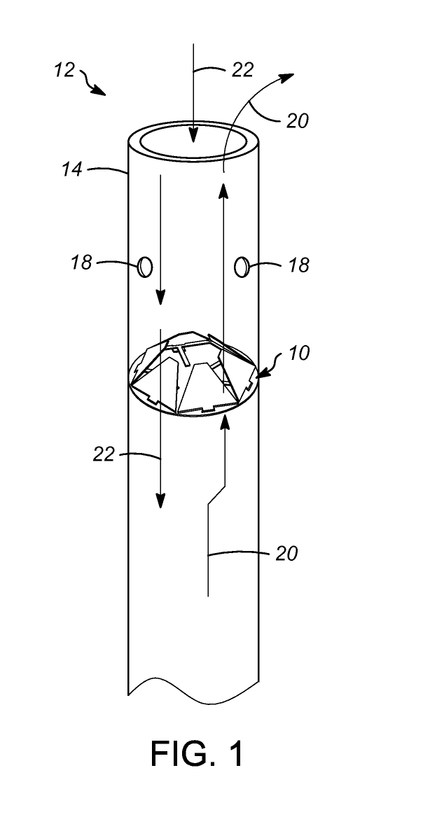

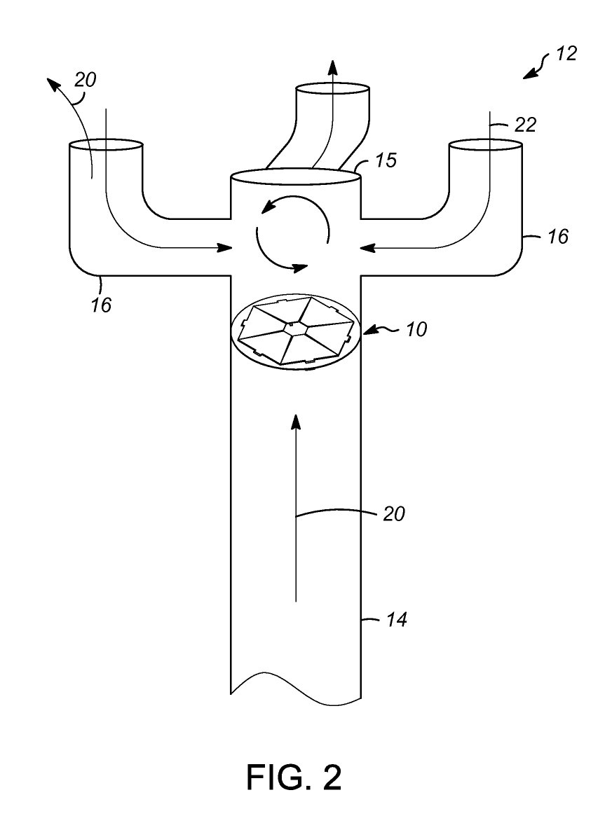

Referring to the figures of the drawings, wherein like numerals of reference designate like elements throughout the several views, and initially to FIGS. 1 and 2, a flare gas actuated velocity seal 10 is used in a flare stack 12 that burns off flammable liquids or gases, such as those released by pressure relief valves (not shown) in industrial plants. The velocity seal 10 is actuated by increases and/or decreases in the pressure of a flare gas flow 20 in the flare stack 12. For purposes of exemplification and not limitation, the velocity seal 10 can be utilized within a single main flare stack 14 as shown in FIG. 1 or can be assembled in radial arm assemblies 16 in fluid communication with the main flare stack 14 having a closed end 15 as shown in FIG. 2. The stack 12 may also include multiple discharge openings 18 to provide maximum emission of a fuel and air mixture at sufficient velocity to prevent flashback in the stack 12. The discharge openings 18 may be round or other geometric shape, and may be of varied or of similar sizes to facilitate uniform velocity of the flare gas flow 20 through the stack 12. While the size of the discharge openings 18 may be varied for optimal flame propagation and uniform velocity of the flare gas flow 20, increasing the size of the discharge openings 18 may result in a reverse air flow 22 back inside the stack 12 with a higher probability of flashback.

The velocity seal 10 is positioned upstream of a burner tip (not shown) within a path of the gas flow 20 through the stack 12, such as in the main flare stack 14 (FIG. 1) and/or in one or more of the radial arm assemblies 16 branching off of the main flare stack 14 (FIG. 2). The inventive velocity seal 10 and method of use provide a back-pressure to the flare gas flow 20 that is generally constant in proportion to the gas flow 20 preventing air 22 from flowing into the stack 12 even at very low rates.

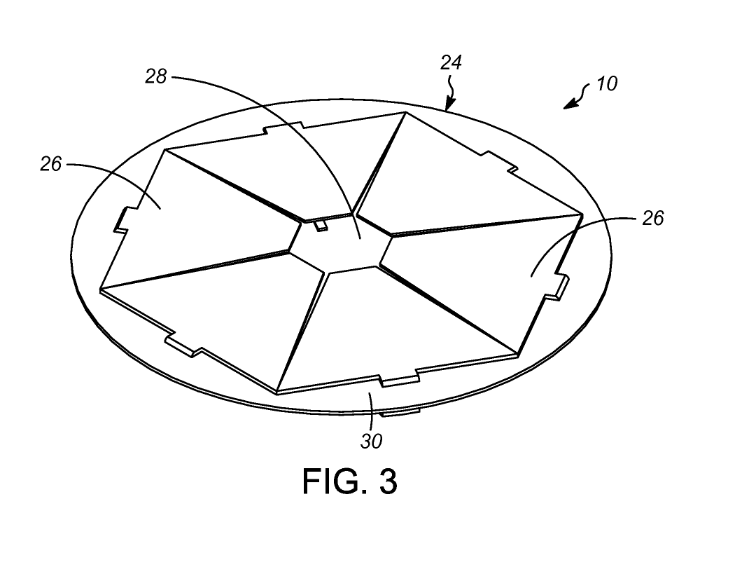

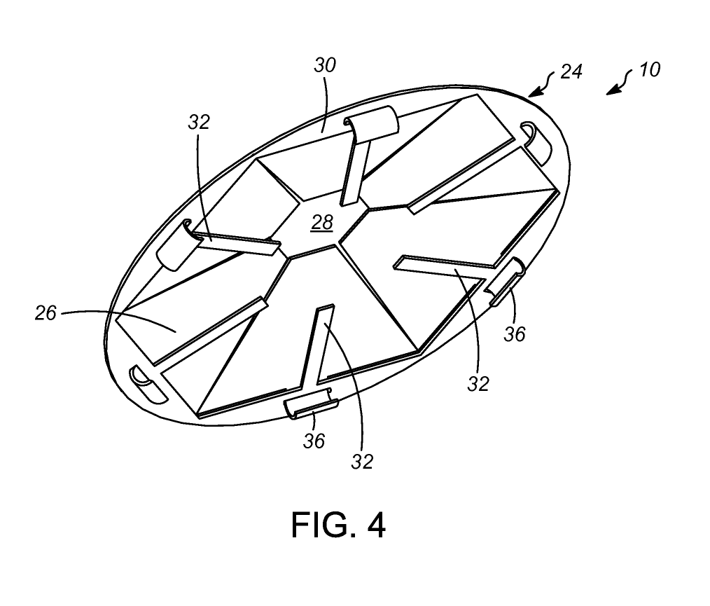

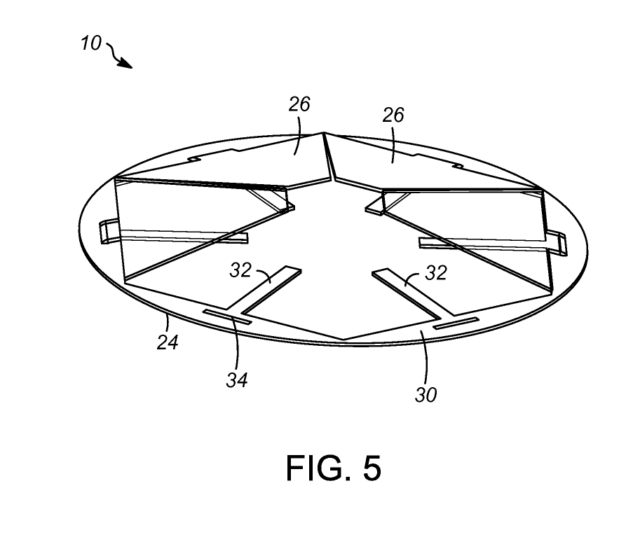

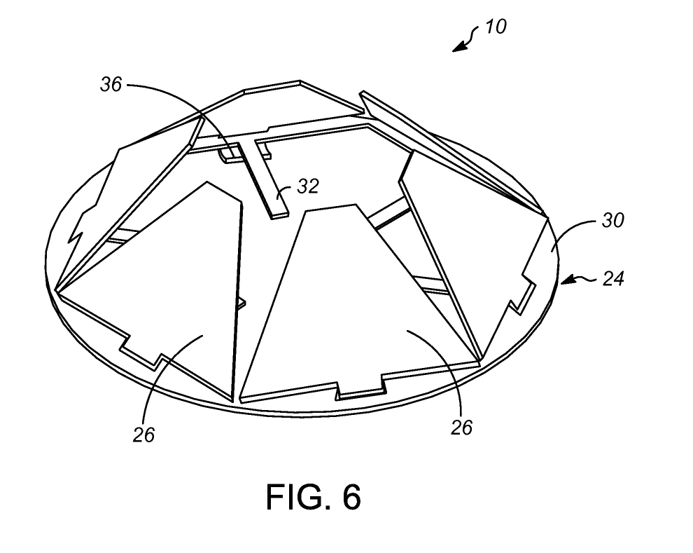

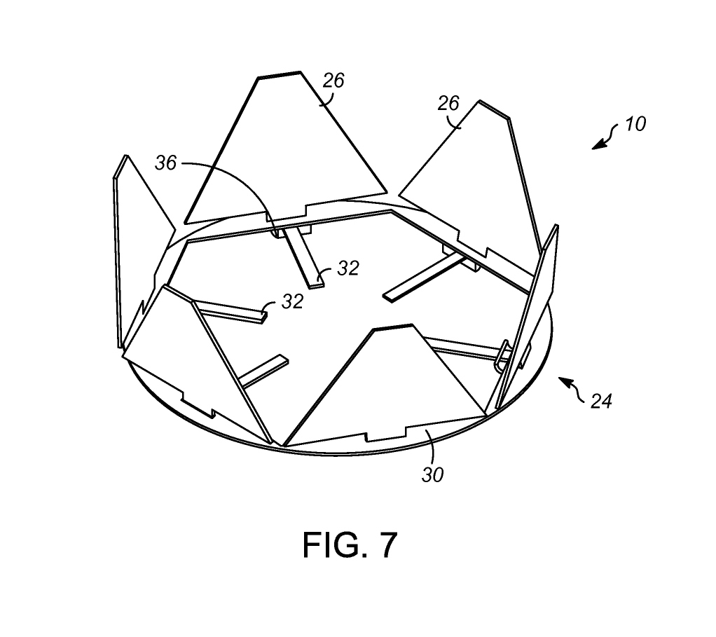

Turning now to FIGS. 3-7, the velocity seal 10 includes a base 24 supporting a plurality of radially converging flaps 26, which form a central bore 28 through the seal 10. As illustrated in the drawings, the base 24 may include an annular body 30 having a plurality of radially converging support arms 32. The radially converging flaps 26 are connected to the base 24 such that when the gas flow 20 rate is low, the flaps 26 are only partially open (FIG. 6) and when the flare gas flow 20 pressure increases, the flaps 26 open further (FIG. 7). The flaps 26 may be pivotally attached to slotted receiving apertures 34 in the base 24, such as by shoulders 36 at terminal ends of the flaps 26 or other bearings joined to the base 24. As shown in the drawings, the shoulders 36 can include bends (e.g., radial curvatures for low flow applications or approximately 90° bends for high flow applications) forming upper stops during high-flow operation (FIG. 7). The support arms 32 form lower stops for the flaps 26 of the velocity seal 10 during low-flow pressures (FIG. 3).

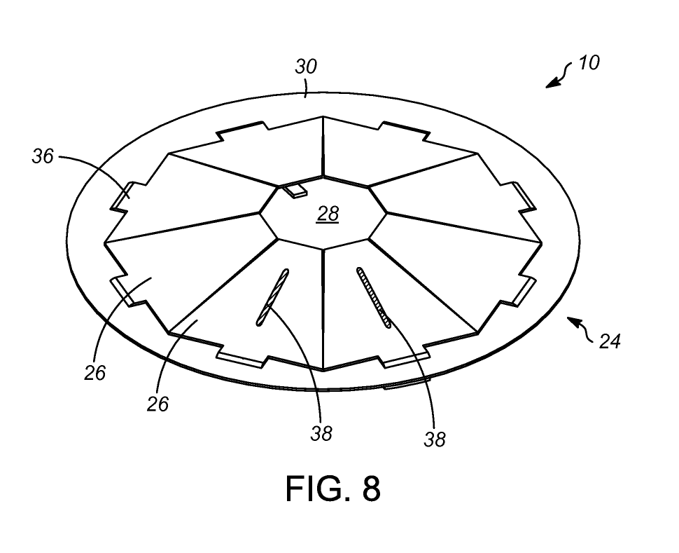

In addition, the velocity seal 10 can be tuned to a specific required back-pressure, such as by making apertures 38 in and/or otherwise changing the dimensions and/or configuration of the flaps 26, such as illustrated in FIG. 8. For illustrative purposes, the velocity seal 10 is shown in FIGS. 3-7 as having a hexagonal configuration with six (6) flaps 26; however, the invention disclosed herein is not so limited as other geometric, polygon configurations with more or less flaps 26 may be utilized, for example, an octagonal configuration having eight (8) flaps 26 as exemplified in FIG. 8. Similarly, the body 24 is not limited to having six (6) support arms 32, and more or less support arms 32 can be utilized with the velocity seal 10 and method of use thereof disclosed herein. The velocity seal 10 may be constructed of metal plate in order to keep production costs low, but may be constructed of any resilient, non-reactive material that is suitable for the particular application and usage of the invention.

Whereas, the devices and methods have been described in relation to the drawings and claims, it should be understood that other and further modifications, apart from those shown or suggested herein, may be made within the scope of this invention.

### Specific Embodiments

While the following is described in conjunction with specific embodiments, it will be understood that this description is intended to illustrate and not limit the scope of the preceding description and the appended claims.

A first embodiment of the invention is a flare gas actuated velocity seal, comprising a base supporting a plurality of radially converging flaps, the flaps forming a central bore through the seal; and the flaps pivotally connected to the base and movable between a closed position and an open position. An embodiment of the invention is one, any or all of prior embodiments in this paragraph up through the first embodiment in this paragraph wherein the base further comprises an annular body having a plurality of radially converging support arms. An embodiment of the invention is one, any or all of prior embodiments in this paragraph up through the first embodiment in this paragraph wherein the support arms form lower stops for the flaps. An embodiment of the invention is one, any or all of prior embodiments in this paragraph up through the first embodiment in this paragraph further comprising the flaps pivotally connected to slotted receiving apertures in the base. An embodiment of the invention is one, any or all of prior embodiments in this paragraph up through the first embodiment in this paragraph wherein each of the flaps further comprises a shoulder. An embodiment of the invention is one, any or all of prior embodiments in this paragraph up through the first embodiment in this paragraph wherein the shoulders further comprises terminal ends forming upper stops for the flaps. An embodiment of the invention is one, any or all of prior embodiments in this paragraph up through the first embodiment in this paragraph wherein one or more of the flaps further comprises a tuning aperture.

A second embodiment of the invention is a method of controlling a flow of a flare gas in a flare stack using the flare gas actuated velocity seal. An embodiment of the invention is one, any or all of prior embodiments in this paragraph up through the second embodiment in this paragraph wherein the velocity seal is movable between the open position and the closed position in response to increases and/or decreases in the pressure of the flare gas in the flare stack. An embodiment of the invention is one, any or all of prior embodiments in this paragraph up through the second embodiment in this paragraph further comprising the step of providing a back-pressure to the flare gas with the flaps of the velocity seal generally constant in proportion to the pressure of the flare gas preventing air from flowing into the stack.

A third embodiment of the invention is a method of controlling a flow of a flare gas in a flare stack, the method comprising the steps of providing the flow of the flare gas to a flare gas actuated velocity seal positioned upstream of a burner tip in the flare stack; and providing a back-pressure with a plurality of radially converging flaps of the velocity seal in generally constant proportion to the pressure of the flare gas preventing air from flowing into the stack. An embodiment of the invention is one, any or all of prior embodiments in this paragraph up through the third embodiment in this paragraph wherein the flaps of the velocity seal are movable between an open position and a closed position in response to an increase and/or a decrease in the pressure of the flare gas in the flare stack. An embodiment of the invention is one, any or all of prior embodiments in this paragraph up through the third embodiment in this paragraph further comprising the step of providing the velocity seal in a flow path of the flare gas in a single main flare stack. An embodiment of the invention is one, any or all of prior embodiments in this paragraph up through the third embodiment in this paragraph further comprising the step of providing the velocity seal in a flow path of the flare gas in one or more of radial arm assemblies in fluid communication with the flare stack.

Without further elaboration, it is believed that using the preceding description that one skilled in the art can utilize the present invention to its fullest extent and easily ascertain the essential characteristics of this invention, without departing from the spirit and scope thereof, to make various changes and modifications of the invention and to adapt it to various usages and conditions. The preceding preferred specific embodiments are, therefore, to be construed as merely illustrative, and not limiting the remainder of the disclosure in any way whatsoever, and that it is intended to cover various modifications and equivalent arrangements included within the scope of the appended claims.

In the foregoing, all temperatures are set forth in degrees Celsius and, all parts and percentages are by weight, unless otherwise indicated.

1. A flare gas actuated velocity seal, comprising:
a base supporting a plurality of radially converging flaps, said flaps forming a central bore through said seal; and
said flaps pivotally connected to said base and movable between a closed position and an open position.

2. The velocity seal of claim 1 wherein said base further comprises an annular body having a plurality of radially converging support arms.

3. The velocity seal of claim 2 wherein said support arms form lower stops for said flaps.

4. The velocity seal of claim 1 further comprising said flaps pivotally connected to slotted receiving apertures in said base.

5. The velocity seal of claim 4 wherein each of said flaps further comprises a shoulder.

6. The velocity seal of claim 5 wherein said shoulders further comprises terminal ends forming upper stops for said flaps.

7. The velocity seal of claim 1 wherein one or more of said flaps further comprises a tuning aperture.

8. A method of controlling a flow of a flare gas in a flare stack using said flare gas actuated velocity seal of claim 1.

9. The method of claim 8 wherein said velocity seal is movable between said open position and said closed position in response to increases and/or decreases in the pressure of said flare gas in said flare stack.

10. The method of claim 8 further comprising the step of providing a back-pressure to said flare gas with said flaps of said velocity seal generally constant in proportion to the pressure of said flare gas preventing air from flowing into said stack.

11. A method of controlling a flow of a flare gas in a flare stack, said method comprising the steps of:
providing said flow of said flare gas to a flare gas actuated velocity seal positioned upstream of a burner tip in said flare stack; and
providing a back-pressure with a plurality of radially converging flaps of said velocity seal in generally constant proportion to the pressure of said flare gas preventing air from flowing into said stack.

12. The method of claim 11 wherein said flaps of said velocity seal are movable between an open position and a closed position in response to an increase and/or a decrease in said pressure of said flare gas in said flare stack.

13. The method of claim 11 further comprising the step of providing said velocity seal in a flow path of said flare gas in a single main flare stack.

14. The method of claim 11 further comprising the step of providing said velocity seal in a flow path of said flare gas in one or more of radial arm assemblies in fluid communication with said flare stack.
